(19) United States
(12) Patent Application Publication
(10) Pub. No.: US 2010/0110543 A1
(43) Pub. Date: May 6, 2010

(54) LAMINATED QUARTER WAVE PLATE

(75) Inventors: Satoshi KAIZAWA, Machida (JP); Masayuki OTO, Zama (JP); Hiroshi MATSUMOTO, Chigasaki (JP)

Correspondence Address: HARNESS, DICKEY & PIERCE, P.L.C., P.O. BOX 828, BLOOMFIELD HILLS, MI, 48303, US

(73) Assignee: EPSON TOYOCOM CORPORATION, Tokyo (JP)

(21) Appl. No.: 12/607,303

(22) Filed: Oct. 28, 2009

(30) Foreign Application Priority Data
Oct. 31, 2008 (JP) 2008-282531

(51) Int. Cl. G02B 5/30; G02B 1/08

(52) U.S. Cl. 359/499

(57) ABSTRACT

A laminated quarter wave plate includes: a first wave plate made of an optically uniaxial crystal material; and a second wave plate made of an optically uniaxial crystal material. In the laminated quarter wave plate, the first and second wave plates are disposed in this order from an entrance side of light so that the optical axes of the first and second wave plates intersect with each other at an angle of 90°, and a phase difference Γ₁ of the first wave plate, a phase difference Γ₂ of the second wave plate, an optical axis azimuth angle θ₁ of the first wave plate, an optical axis azimuth angle θ₂ of the second wave plate, an allowable deviation γ of the phase difference of the first wave plate, allowable deviations k₁, k₂ of the optical axis azimuth angles of the first and second wave plates satisfy the following relation:

Γ₁=360°+γ+n×360°, where −90°≦γ≦+90°, and n is a nonnegative integer;

Γ₂=Γ₁−90° or Γ₂=Γ₁−270°;

θ₁=45°+k₁; and

θ₂=135°+k₂,

and γ, k₁, k₂ are determined so that a polarization state of outgoing light satisfies a desired ellipticity.

### BACKGROUND

1. Technical Field

The present invention relates to a quarter wave plate used in an optical device such as an optical pickup device, a liquid crystal projector, or an optical low pass filter, and in particular to a laminated quarter wave plate that is composed of two wave plates made of an inorganic crystal material having a birefringent property, such as a quartz crystal, and arranged in a stacked manner.

2. Related Art

In the past, a phase plate shifting the phase of the incident light by one quarter wavelength thereof in order for converting the polarization state between linearly polarized light and circular polarized light, namely a quarter wave plate, is used in various optical usages. In general, the quarter wave plate is made of a resin film made of an organic material such as polycarbonate to which the birefringent property is provided by a drawing process, a retardation plate having a polymeric liquid crystal layer held between transparent substrates, or a crystal plate made of an inorganic crystalline material having a birefringent property, such as quartz crystal. In particular, an optical pickup device used for recording/reproduction in an optical disk drive adopts a blue-violet laser with an extremely short wavelength and high power in order for achieving high density and high capacity recording. The resin film and the liquid crystal material described above are likely to be heated by absorbing the blue-violet laser beam, and thus the material itself might be deteriorated to damage the function as the wave plate. In contrast, the inorganic crystalline material such as quartz crystal has extremely high light resistance. The quartz crystal wave plate is, thus, particularly advantageous to the optical system using the blue-violet laser.

The thickness t of the quartz crystal wave plate is determined along the following well-known relational expression with the phase difference Γ.

Γ=(360/λ)·(ne−no)t (where, no: ordinary refractive index, ne: extraordinary refractive index)

Therefore, if a single mode (zero-order mode) quarter wave plate is formed of a so-called Y-cut (or X-cut) quartz crystal plate carved out so that the normal line erected on the entrance surface (or the exit surface) of the light and the crystal optical axis of the quartz crystal, namely the Z-axis, are perpendicular to each other, the thickness of the quartz crystal plate used is reduced to be in a range of about 10 through 26 μm in accordance with the use wavelength, thus the strength is significantly deteriorated, and the handling in the manufacturing process becomes extremely difficult. Therefore, a laminated quarter wave plate composed of two or more quartz crystal wave plates bonded to each other is used (see, e.g., JP-A-58-189605 and JP-B-3-61921).

The combined wave plate described in JP-A-58-189605 has two crystal plates, each of which is carved from an optically uniaxial crystal such as quartz crystal in parallel to the optical axis Z, namely so that the optical axis Z is perpendicular to the normal line erected on the entrance surface (or the exit surface) of the light, so as to be combined to have the respective optical axes Z perpendicular to each other, and is arranged so that the light path difference Δd between the light beams passing respectively through the pair of crystal plates is represented as Δn×Δt, wherein Δn denotes the difference in refractive index between the ordinary light beam and the extraordinary light beam of the crystal plate, Δt denotes the difference in thickness between the both crystal plates. Thus, the problem of the optical optical rotatory power and the incident angle dependence the optically uniaxial crystal material has is solved in addition to the problem that the thickness of the plate becomes smaller.

The combined wave plate described in JP-B-3-61921 is obtained by bonding two crystal plates, each of which is processed so that the plate surface normal line, namely the normal line erected on the entrance surface (or the exit surface) of the light, and the optical axis form an angle β satisfying 0°<β<90°. These crystal plates are bonded to each other so that the optical axes thereof are symmetric about the bonded surface, and parallel to each other when viewed from the normal direction of the plate surface. Thus, it is possible to cancel the variation of the retardation caused by the variation of the incident angle of the beam.

Further, there is known a quarter wave plate having two optically anisotropic crystal bonded to each other so that the respective slow axes are substantially perpendicular to each other (see e.g., JP-A-2003-222724). According to such a configuration, the quarter wave plate eliminates the distortion caused by the thermal contraction due to the temperature variation in the case of using a film of resin such as polycarbonate, and eliminates the dependence of the retardation value on the incident light beam angle in the optically anisotropic crystal, thereby realizing high contrast.

Similarly, there is known a structure arranged to exert a desired function as a quarter wave plate, also in the case in which the laminated quarter wave plate composed of two optical crystal plates bonded to each other is disposed slightly obliquely to the light path by stacking them with the optical axes previously shifted from each other in prospect of the shift in the optical axes of the both crystal plates caused therefrom (see, e.g., JP-A-2006-40359).

Further, the laminated quarter wave plate is also used for exerting the function as the quarter wave plate in a broader spectrum. For example, there is proposed a quarter wave plate composed of two wave plates made of an optical material having optical rotatory power stacked so as to overlap with each other with the optical axes intersect with each other, and arranged so that the phase difference, optical axis azimuth angle, optical rotatory power, and the angle formed between the rotation axis and the neutral axis satisfy a predetermined relational expression, thereby improving the characteristic in a broad spectrum while reducing the influence from the optical rotatory power (see, e.g., JP-A-2005-158121).

There is also known a depolarization plate having three wave plates stacked to each other so as to function as the quarter wave plate in further broader spectrum (see, e.g., JP-A-2006-113123). In this quarter wave plate, the phase difference between the wave plate and an in-plane azimuth angle are designed to be the optimum values using the Poincare sphere.

FIG. 18 shows a typical example of the quarter wave plate in the related art. The laminated quarter wave plate 11 has first and second wave plates 12, 13 made of optically uniaxial crystal material such as a Y-cut (or X-cut) quartz crystal plate in this order from the incident side Li to the exit side Lo of the light. The first wave plate 12 is designed to have a phase difference Γᵢ and an optical axis azimuth angle θ₁ satisfying the following expressions.

Γ₁=180°+n₁×360° (where n₁ denotes a nonnegative integer)

θ₁=45°

The second wave plate 13 is designed to have a phase difference Γ₂ and an optical axis azimuth angle θ₂ satisfying the following expressions.

Γ₂=90° (or 270°)+n₂×360° (where n₂: a normegative integer)

θ₂=135°

The first and second wave plates described above are bonded to each other so that the crystal optical axes 14, 15 thereof intersect with each other at 90°. The phase difference Γ=|Γ₁−Γ₂|=90° (or 270°) forms the phase difference of the laminated quarter wave plate 11. Here, the optical axis azimuth angle θ₁ is an angle formed between the polarization plane of the linearly polarized light entering the laminated quarter wave plate and the crystal optical axis 14 of the first wave plate 12, and the optical axis azimuth angle θ₂ is an angle formed between the polarization plane of the linearly polarized light and the crystal optical axis 15 of the second wave plate 13.

The polarization state of the laminated quarter wave plate will be explained using the Poincaré sphere shown in FIG. 19. Assuming the reference point P₀ of the incident light as P₀=(1, 0, 0), the rotation axis R₁ of the first wave plate 12 is set at a position where it is rotated 2θ₁=90° from the S1 axis, and the rotation axis R₂ of the second wave plate 13 is set at a position where it is rotated 2θ₂=270° from the S1 axis. Firstly, when the reference point P₀ is rotated an amount corresponding to the phase difference Γ₁ rightward around the rotation axis R₁, a point P₁=(−1, 0, 0) becomes the position of the outgoing light of the first wave plate. Subsequently, when the point P₁ is rotated an amount corresponding to the phase difference Γ₂ rightward around the rotation axis R₂, a point P₂=(0, 0, 1) becomes the position of the outgoing light of the second wave plate, namely the position of the outgoing light of the laminated quarter wave plate 11.

However, in the laminated quarter wave plate manufactured actually, it is difficult to realize the ideal polarization state shown in FIG. 19. Firstly, since the optical axis azimuth angles θ1, θ2 of the first and second wave plates 12, 13 are determined by the angle with which a quartz crystal plate as a mother board forming the first and second wave plates is mechanically cut with respect to the optical axis thereof, a manufacturing error around ±0.5° is generally caused. Further, also when dividing the mother board thus carved out into discrete wave plates, a manufacturing error around ±0.5° is generally caused in the optical axis azimuth angles θ1, θ2. Further, when bonding the first and second wave plates thus formed as discrete parts to each other so that the optical axes thereof intersect with each other at an angle of 90°, an assembly error is caused. The manufacturing error in the carving process and dividing process and the assembly error in the bonding process in the optical axis come to a total of about ±3.0°, and therefore, might exert a harmful influence directly to the polarization state of the outgoing light of the laminated quarter wave plate.

The influence exerted to the polarization state of the outgoing light of the laminated quarter wave plate 11 by the errors of ±Δθ₁, ±Δθ₂ caused in the optical axis azimuth angles of the first and second wave plates 12, 13 in the case in which the errors are caused will be explained with reference to FIG. 20. The drawing shows an appearance of the Poincare sphere viewed in a direction from S3, namely the north pole. Assuming the reference point P₀ of the incident light as P₀=(1, 0, 0), the rotation axes R₁⁺, R₁⁻ of the first wave plate 12 are set at positions rotated 2θ₁=90°±Δθ₁ from the optical axis S1, respectively. Similarly, the rotation axes R₂⁺, R₂⁻ of the second wave plate 13 are set at positions rotated 2θ₂=270°±Δθ₂ from the optical axis S1, respectively.

Firstly, when the reference point P₀ is rotated an amount corresponding to the phase difference Γ₁ rightward around the rotation axis R₁⁺, the position P₁⁺ of the outgoing light of the first wave plate described above on the sphere comes to the position where it is rotated 2Δθ₁ leftward further from the point P₁=(−1, 0, 0) shown in FIG. 17. Subsequently, when the point P₁⁺ is rotated an amount corresponding to the phase difference Γ₂ rightward around the rotation axis R₂⁺ or R₂⁻, a point P₂⁺⁺ or P₂⁺⁻ on the sphere becomes the position of the outgoing light of the second wave plate, namely the position of the outgoing light of the laminated quarter wave plate 11.

Further, when the reference point P₀ is rotated an amount corresponding to the phase difference Γ₁ rightward around the rotation axis R₁⁻, the position P₁⁻ of the outgoing light of the first wave plate described above on the sphere comes to the position where it is rotated 2Δθ₁ so as to be reversed rightward from the point P₁=(−1, 0, 0) shown in FIG. 19. Subsequently, when the point P₁⁻ is rotated an amount corresponding to the phase difference Γ₂ rightward around the rotation axis R₂⁺ or R₂⁻, a point P₂⁻⁺ or P₂⁻⁻ on the sphere becomes the position of the outgoing light of the second wave plate, namely the position of the outgoing light of the laminated quarter wave plate 11. It is understood that these positions of the outgoing light are both significantly shifted from the point P2=(0, 0, 1), namely the position of the north pole shown in FIG. 19, and the ellipticity thereof can dramatically drop from 1.

Secondly, the phase difference Γ of the quartz crystal plate is adjusted by controlling the plate thickness t by the oscillating frequency thereof based on the relational expression with the plate thickness t described above. Therefore, the manufacturing error of the plate thickness t directly causes the error of the phase difference. For example, the error of 0.5 μm in the Y-cut quartz crystal plate leads to the error of about 3° in the retardation. It is extremely difficult and cause heavy price to manufacture both of two quartz crystal wave plates so as to have thickness with high accuracy, and to use them in combination.

As described above, due to the manufacturing error in the optical axes of the first and second wave plates, the assembly error of the bonding process, and the manufacturing error of the phase difference between the wave plates exerting thereon in an overlapping manner, the ellipticity of the laminated quarter wave plate is further dropped. Although the bonding error between the wave plates can be eliminated by executing the bonding with accuracy while checking the orientations of the optical axes thereof using an X-ray device, there is caused a problem of lacking in mass productivity, which causes increase in manufacturing cost.

The inventors of the invention have conducted a specific simulation on how much influence these errors actually exert on the ellipticity of the laminated quarter wave plate. FIG. 21 shows the variation of the ellipticity in the case, in which the phase difference Γ₁ and the optical axis azimuth angle θ₁ of the first wave plate, and the phase difference Γ₂ and the optical axis azimuth angle θ₂ of the second wave plate are assumed as the following expressions in the laminated quarter wave plate at the wavelength of 660 nm used in an optical pickup device installed in a commercially available DVD standard optical disk recording/reproducing drive, in the range of the wavelength λ of 620 through 700 nm.

Γ₁=180°+7×360°=2700°

θ₁=45°−2°=43°

Γ₂=90°+7×360°=2610°

θ₂=135°+2°=137°

According to the drawing, it is understood that the ellipticity underruns the target reference value of 0.85 in most of the range of use of the wavelength λ of 640 through 680 nm.

FIG. 22 shows the variation of the ellipticity in the case, in which the optical axis azimuth angle θ₁ of the first wave plate and the optical axis azimuth angle θ₂ of the second wave plate are assumed as the following expressions, and the phase difference Γ₁ of the first wave plate is varied in the range of ±180° around the value in the following expression in the laminated quarter wave plate at the wavelength of 660 nm used similarly in a DVD standard optical pickup device, in the range of the wavelength λ of 620 through 700 nm.

θ₁=45°−2°=43°

θ₂=135°+2°=137°

Γ₁=180°+7×360°=2700°

It should be noted that the phase difference Γ₂ of the second wave plate is obtained by the following expression.

Γ₂=Γ₁−90°

According to the drawing, it is understood that the ellipticity is unstable and the range where the ellipticity underruns the target reference value of 0.85 always exists in the range of use of the wavelength λ of 640 through 680 nm irrespective of the phase difference Γ₁ of the first wave plate.

FIG. 23 shows the variation of the ellipticity in the case, in which the phase difference Γ₁ and the optical axis azimuth angle θ₁ of the first wave plate, and the phase difference Γ₂ and the optical axis azimuth angle θ₂ of the second wave plate are assumed as the following expressions in the laminated quarter wave plate at the wavelength of 405 nm used in an optical pickup device installed in a commercially available Blu-ray standard optical disk recording/reproducing drive, in the range of wavelength λ of 375 through 435 nm.

Γ₁=180°+9×360°=3420°

θ₁=45°−2°=43°

Γ₂=90°+9×360°=3330°

θ₂=135°+2°=137°

According to the drawing, it is understood that the ellipticity underruns the target reference value of 0.9 in most of the range of use of the wavelength λ of 395 through 415 nm.

FIG. 24 shows the variation of the ellipticity in the case, in which the optical axis azimuth angle θ₁ of the first wave plate and the optical axis azimuth angle θ₂ of the second wave plate are assumed as the following expressions, and the phase difference Γ₁ of the first wave plate is varied in the range of ±180° around the value in the following expression in the laminated quarter wave plate at the wavelength of 405 nm used similarly in a Blu-ray standard optical pickup device, in the range of the wavelength λ of 375 through 435 nm.

θ₁=45°−2°=43°

θ₂=135°+2°=137°

Γ₁=180°+9×360°=3420°

It should be noted that the phase difference Γ₂ of the second wave plate is obtained by the following expression.

Γ₂=Γ₁−90°

According to the drawing, it is understood that the ellipticity is unstable and the range where the ellipticity underruns the target reference value of 0.9 always exists in the range of use of the wavelength λ of 395 through 415 nm irrespective of the phase difference Γ₁ of the first wave plate.

### SUMMARY

In view of the problems of the related art, the invention has an advantage of improving the summative degradation of the ellipticity by the manufacturing errors of the phase difference and the optical axis of each of the wave plates and the bonding error of the two wave plates in the laminated quarter wave plate having the first wave plate and the second wave plate made of an optically uniaxial crystal material disposed so that the optical axes thereof intersect with each other at an angle of 90°, thereby realizing the polarization state with a high ellipticity, and achieving reduction of the manufacturing cost and improvement in mass productivity.

As described above, in the optical axis azimuth angle of the quartz crystal wave plate, an error of about ±3° in the manufacturing process is thought to be an unavoidable tolerance. In contrast, the phase difference of the quartz crystal wave plate is determined by the thickness thereof as described above, and therefore, can be controlled with relatively high accuracy. Therefore, the inventors of the invention have conducted a study on whether or not the ellipticity of the laminated quarter wave plate can be improved by appropriately setting the phase difference of the first wave plate, the second wave plate, or each of the first and second wave plates.

The inventors of the invention have found out the fact that the manufacturing error, namely the shift, of the optical axis azimuth angle θ₁ of the first wave plate can be eliminated by setting the phase difference Γ₁ of the first wave plate and the phase difference Γ₂ of the second wave plate as the following expressions.

Γ₁=360°+n×360° (where n: a nonnegative integer)

Γ₂=Γ₁−90° or Γ₂=Γ₁−270°

This will be explained using the Poincare sphere shown in FIG. 1. The drawing shows an appearance of the Poincare sphere viewed in a direction from S3 axis, namely the north pole.

The case in which errors ±Δθ₁, ±Δθ₂ are caused in the optical axis azimuth angles θ₁, θ₂ of the first and second wave plates, respectively, similarly to the case with FIG. 20 is considered. Assuming the reference point P₀ of the incident light as P₀=(1, 0, 0), the rotation axes R₁⁺, R₁⁻ of the first wave plate are set at positions rotated 2θ₁=90°±2Δθ₁ from the axis S1, respectively. Similarly, the rotation axes R₂⁺, R₂⁻ of the second wave plate are set at positions rotated 2θ₂=270°±2Δθ₂ from the axis S1, respectively.

Firstly, when the reference point P₀ is rotated an amount corresponding to the phase difference Γ₁ rightward around the rotation axis R₁⁺, a point P₁ of the outgoing light of the first wave plate on the sphere necessarily returns to the position of the original reference point P₀. Similarly, also in the case in which the reference point P₀ is rotated an amount corresponding to the phase difference Γ₁ rightward around the rotation axis R₁⁻, a point P₁ of the outgoing light of the first wave plate on the sphere necessarily returns to the position of the original reference point P₀. Subsequently, when the point P₁ is rotated an amount corresponding to the phase difference Γ₂ rightward around the rotation axis R₂⁺ or R₂⁻, a point P₂⁺ or P₂⁻ on the sphere becomes the position of the outgoing light of the second wave plate, namely the position of the outgoing light of the laminated quarter wave plate. The points P₂⁺, P₂⁻ are intersections between the straight lines passing through the position P₁ and crossing perpendicularly to the rotation axes R₂⁺, R₂⁻, and the rotation axes R₂⁺, R₂⁻, respectively. Therefore, it is understood that the polarization state, namely the ellipticity, of the outgoing light of the laminated quarter wave plate is determined by the accuracy of the optical axis azimuth angle of the second wave plate irrespective of the shift amount of the optical axis azimuth angle of the first wave plate.

In reality, since the manufacturing error is caused in the phase difference Γ₁ of the first wave plate, the position of the point P₁ moves on a straight line passing through the reference point P₀ and crossing perpendicularly to the rotation axes R₁⁺, R₁⁻ shown in FIG. 1 in accordance with the amplitude of the manufacturing error. The variation in the polarization state due to this movement is thought to be eliminated by setting the phase difference Γ₂ of the second wave plate in accordance with the actual value of the phase difference F1 so that the difference always maintains 90°. The invention is made based on such a finding.

According to an aspect of the invention, there is provided a laminated quarter wave plate including a first wave plate made of an optically uniaxial crystal material, and a second wave plate made of an optically uniaxial crystal material, the first and second wave plates are disposed in this order from an entrance side of light so that the optical axes of the first and second wave plates intersect with each other at an angle of 90°, a phase difference Γ₁ of the first wave plate, a phase difference Γ₂ of the second wave plate, an optical axis azimuth angle θ₁ of the first wave plate, and an optical axis azimuth angle θ₂ of the second wave plate are set as following expressions, and an allowable deviation γ of the phase difference of the first wave plate, allowable deviations k₁, k₂ of the optical axis azimuth angles of the first and second wave plates are determined so that a polarization state of outgoing light satisfies a desired ellipticity.

Γ₁=360°+γ+n×360° (where −90°≦γ≦+90°, n: a nonnegative integer)

Γ₂=Γ₁−90° or Γ₂=Γ₁−270°

θ₁=45°+k₁

θ₂=135°+k₂

Since the manufacturing error in the optical axis azimuth angle of the first wave plate does not at all affect the ellipticity of the laminated quarter wave plate, the first wave plate can be manufactured with relatively low accuracy and at low cost. Even in the case of adopting the above, a desired higher ellipticity can be achieved more easily than in the related art in the laminated quarter wave plate by keeping the accuracy of the optical axis azimuth angle θ₂ and the phase difference Γ₂ of the second wave plate in a high level. Moreover, since the first and second wave plates can be disposed using a mechanical technique similar to the related art and with positioning accuracy of substantially the same level as in the related art, it is possible to achieve reduction of the manufacturing cost and improvement of the mass productivity. It should be noted that the polarization state of the outgoing light comes to the position of the north pole on the Poincare sphere in the case in which the phase difference Γ₂ of the second wave plate satisfies Γ₂=Γ₁−90°, while it comes to the position of the south pole on the Poincare sphere in the case in which the phase difference Γ₂ satisfies Γ₂=Γ₁−270°.

In a certain aspect of the invention, the center wavelength of the laminated quarter wave plate is in a 660 nm band generally used in the DVD standard optical pickup device, and by setting the optical axis azimuth angles of the first wave plate and the second wave plate respectively to the ranges of 45°±4°, 135°±4°, the high ellipticity no lower than 0.85 can be achieved.

In another aspect of the invention, the center wavelength of the laminated quarter wave plate is in a 405 nm band generally used in the Blu-ray standard optical pickup device, and by setting the optical axis azimuth angles of the first wave plate and the second wave plate respectively to the ranges of 45°±2.5°, 135°±2.5°, the high ellipticity no lower than 0.9 can be achieved.

According to still another aspect of the invention, since the first and second wave plates are each formed, for example, of a Y-cut or X-cut quartz crystal plate, which has been frequently used from the past, and is not affected by the optical rotatory power of the quartz crystal, the ellipticity of the laminated quarter wave plate can be controlled with relative ease.

### BRIEF DESCRIPTION OF THE DRAWINGS

The invention will now be described with reference to the accompanying drawings, wherein like numbers reference like elements.

FIG. 1 is a diagram for explaining a polarization state of a laminated quarter wave plate according to an embodiment of the invention using the Poincare sphere.

FIG. 2 is a perspective view of the laminated quarter wave plate according to the embodiment of the invention viewed from the side thereof from which the light is output.

FIG. 3 is a diagram showing the variation of the ellipticity to allowable deviation γ of a phase difference Γ₁ with respect to shift amounts of θ₁, θ₂ of ±0° through ±6° in the laminated quarter wave plate with a center wavelength of 660 nm.

FIG. 4A is a diagram showing a variation in the ellipticity to the wavelength in the case in which the shift amounts of θ₁, θ₂ of the laminated quarter wave plate are −2°, +2°, respectively, FIG. 4B is a diagram showing a variation in the ellipticity in the range in which the phase difference Γ₁ is significantly shifted to the negative side, and FIG. 4C is a diagram showing a variation in the ellipticity in the range in which the phase difference Γ₁ is significantly shifted to the positive side.

FIG. 5A is a diagram showing a variation in the ellipticity to the wavelength in the case in which the shift amounts of θ₁, θ₂ of the laminated quarter wave plate are −3°, +3°, respectively, FIG. 5B is a diagram showing a variation in the ellipticity in the negative side of the phase difference Γ₁, and FIG. 4C is a diagram showing a variation in the ellipticity in the range in which the phase difference Γ₁ is shifted to the positive side.

FIG. 6 is a diagram showing a variation in the ellipticity to the wavelength in the case in which the shift amounts of θ₁, θ₂ of the laminated quarter wave plate are −4°, +4°, respectively.

FIG. 7 is a diagram showing a variation in the ellipticity to the wavelength in the case in which the shift amounts of θ₁, θ₂ of the laminated quarter wave plate are −5°, +5°, respectively.

FIG. 8 is a diagram showing a variation in the ellipticity to the wavelength in the case in which the shift amounts of θ₁, θ₂ of the laminated quarter wave plate are −2°.

FIG. 9 is a diagram showing the variation of the ellipticity corresponding to allowable deviation γ of a phase difference Γ₁ with respect to shift amounts of θ₁, θ₂ of ±0° through ±5° in the laminated quarter wave plate with a center wavelength of 405 nm.

FIG. 10A is a diagram showing a variation in the ellipticity to the wavelength in the range of the negative side of the phase difference Γ₁ in the case in which the shift amounts of θ₁, θ₂ of the laminated quarter wave plate are −1°, +1°, respectively, and FIG. 10B is a diagram showing a variation in the ellipticity in the range of the positive side of the phase difference Γ₁.

FIG. 11 is a diagram showing a variation in the ellipticity to the wavelength in the case in which the shift amounts of θ₁, θ₂ of the laminated quarter wave plate are −1.5°, +1.5°, respectively.

FIG. 12A is a diagram showing a variation in the ellipticity to the wavelength in the case in which the shift amounts of θ₁, θ₂ of the laminated quarter wave plate are −2°, +2°, respectively, FIG. 12B is a diagram showing a variation in the ellipticity in the negative side of the phase difference Γ₁, and FIG. 12C is a diagram showing a variation in the ellipticity in the positive side of the phase difference Γ₁.

FIG. 13 is a diagram showing a variation in the ellipticity to the wavelength in the case in which the shift amounts of θ₁, θ₂ of the laminated quarter wave plate are −2.5°, +2.5°, respectively.

FIG. 14 is a diagram showing a variation in the ellipticity to the wavelength in the case in which the shift amounts of θ₁, θ₂ of the laminated quarter wave plate are −3°, +3°, respectively.

FIG. 15 is a diagram showing a variation in the ellipticity to the wavelength in the case in which the shift amounts of θ₁, θ₂ of the laminated quarter wave plate are −2°.

FIG. 16 is a schematic diagram showing a configuration of an optical pickup using the quarter wave plate of the embodiment of the invention.

FIG. 17 is a schematic diagram showing a configuration of an LCOS projector using the quarter wave plate of the embodiment of the invention.

FIG. 18 is a perspective view of the laminated quarter wave plate according to the related art viewed from the side thereof from which the light is output.

FIG. 19 is a diagram for explaining a polarization state of an ideal laminated quarter wave plate of the related art using the Poincare sphere.

FIG. 20 is a diagram for explaining a polarization state of the laminated quarter wave plate of the related art, in the case in which the optical axis azimuth angle has an error, using the Poincare sphere.

FIG. 21 is a diagram showing a variation in the ellipticity due to the error of the optical axis azimuth angle in the laminated quarter wave plate of the wavelength of 660 nm in the related art.

FIG. 22 is a diagram showing a variation in the ellipticity due to the error of the optical axis azimuth angle in the laminated quarter wave plate of the wavelength of 660 nm in the related art, in relation to a variation in a phase difference of the first wave plate.

FIG. 23 is a diagram showing a variation in the ellipticity due to the error of the optical axis azimuth angle in the laminated quarter wave plate of the wavelength of 405 nm in the related art.

FIG. 24 is a diagram showing a variation in the ellipticity due to the error of the optical axis azimuth angle in the laminated quarter wave plate of the wavelength of 405 nm in the related art, in relation to a variation in a phase difference of the first wave plate.

### DESCRIPTION OF EXEMPLARY EMBODIMENTS

Hereinafter, preferred embodiments of the invention will be described in detail with reference to the accompanying drawings.

As shown in FIG. 2, a laminated quarter wave plate 1 of the present embodiment has a first wave plate 2 and a second wave plate 3 both made of an optically uniaxial crystal material such as a Y-cut (or X-cut) quartz crystal plate. The first wave plate 2 and the second wave plate 3 are bonded to each other in this order in a direction from the entrance side Li of the light to the exit side Lo thereof so that the crystal optical axes 4, 5 thereof intersect with each other at an angle of 90°.

The first wave plate 2 is designed to have the phase difference Γ₁ and the optical axis azimuth angle θ₁ satisfying the following expressions.

Γ₁=360°+γ+n×360° (where −90°≦γ≦+90°, n: a nonnegative integer)

θ₁=45°+k₁

The second wave plate 3 is designed to have the phase difference Γ₂ and the optical axis azimuth angle θ₂ satisfying the following expressions.

Γ₂=Γ₁−90°

θ₂=135°+k₂

Here, γ denotes allowable deviation of the phase difference of the first wave plate, and k₁ and k₂ denote allowable deviation of the optical axis azimuth angles of the first and second wave plates 2, 3, respectively. Further, γ, k₁, and k₂ are determined so that the polarization state of the outgoing light from the laminated quarter wave plate 1 satisfy a desired ellipticity. Here, the optical axis azimuth angle θ₁ is an angle formed between the polarization plane of the linearly polarized light entering the laminated quarter wave plate and the crystal optical axis 4 of the first wave plate 4, and the optical axis azimuth angle θ2 is an angle formed between the polarization plane of the linearly polarized light and the crystal optical axis 5 of the second wave plate 3.

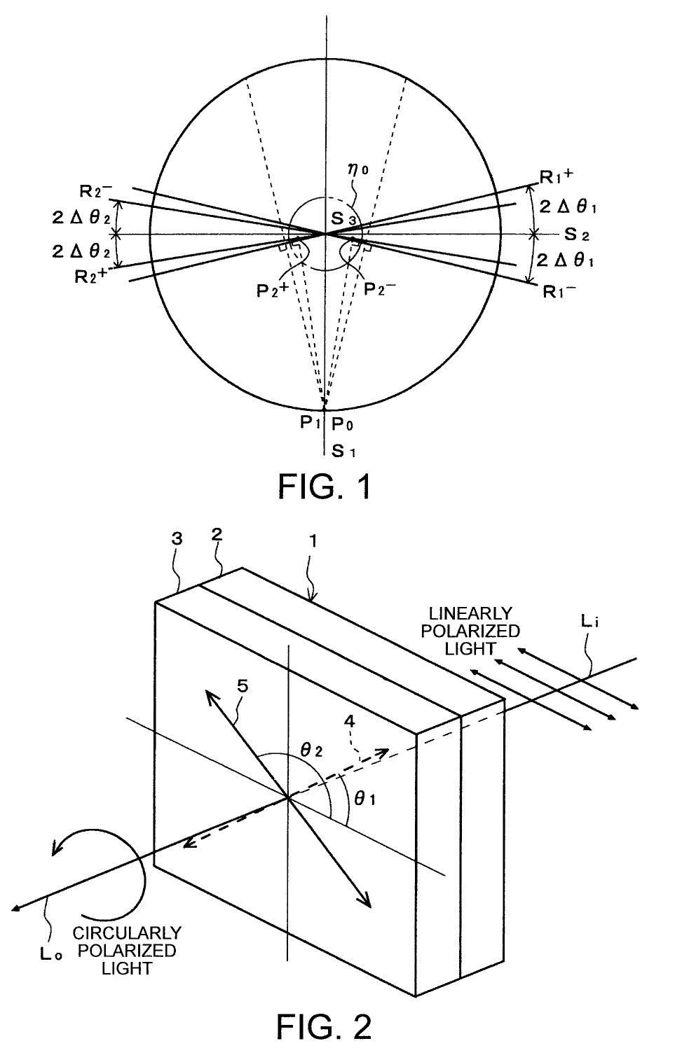

When drawing a circle with a radius of a desired ellipticity 110 around the point S3 with the ellipticity of 1 in the Poincare sphere shown in FIG. 1, γ, k₁, and k₂ are determined so that positions P₂⁺ and P₂⁻ of the outgoing light always exist inside the circle. In the case in which the allowable deviation γ of the phase difference Γ₁ is 0, the position of the point P₁ matches the reference point P₀. In this case, an angle formed between a straight line passing through the reference point P0 and circumscribing the circle with the radius of η₀ described above and the S1 axis corresponds to 2k₂. Within the range of the allowable deviation k₂ of the optical axis azimuth angle θ₂, the positions P₂⁺ and P₂⁻ exist inside the circle with the radius of η0 described above without fail, and satisfy the desired ellipticity of η0.

The position of the point P₁ moves on a straight line passing through the reference point P₀ and perpendicular to the rotation axis R₁⁺ or R₁⁻ in accordance with the allowable deviation γ of the phase difference Γ₁. In this case, the angle defined between the rotation axis R₂⁺ or R₂⁻ perpendicular to a straight line passing through the point P₁ moved from the reference point P₀ and circumscribing the circle with the radius of η0 described above and the S2 axis corresponds to 2k₂. Even in the case in which the phase difference Γ₁ includes manufacturing error, within the range of the allowable deviation k₂ of the optical axis azimuth angle θ₂, the positions P₂⁺ and P₂⁻ exist inside the circle with the radius of η0 described above without fail, and satisfy the desired ellipticity of η0. It is understood that the smaller the allowable deviation k₂ is, the larger allowable deviation γ can be obtained.

As described above, in the laminated quarter wave plate 1 according to the present embodiment of the invention, even in the case in which a shift exists in the optical axis azimuth angle θ₁ of the first wave plate 2, it is prevented that the shift directly affects the polarization state of the outgoing light, namely the ellipticity, and by assuring the accuracy of the optical axis azimuth angle θ₂ and the phase difference Γ₂ of the second wave plate at high levels, the desired high ellipticity can easily be realized while providing a certain extent of width, namely the allowable deviation, to the thickness of the first wave plate 2, namely the phase difference thereof. Therefore, since the first wave plate 2 can be manufactured with relatively low accuracy and at low cost compared to the related art, and can be positioned and bonded to the second wave plate 3 using a mechanical technique similarly to the related art, the manufacturing cost can be reduced.

The laminated quarter wave plate 1 of the present embodiment can be used in a commercially available DVD standard optical pickup device by setting the center wavelength thereof to be 660 nm. In this case, by setting the allowable deviations k₁, k₂ of the optical axis azimuth angles θ₁, θ₂ of the first wave plate 2 and the second wave plate 3 to be ±4°, a desired high ellipticity of 0.85 or more can be obtained. Hereinafter, explanations will be presented while showing specific simulation results.

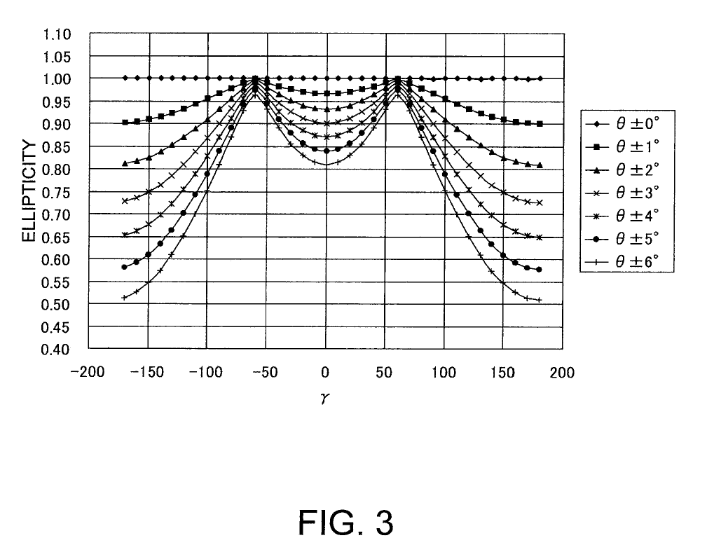

FIG. 3 shows a variation in the ellipticity to the allowable deviation γ of the phase difference Γ₁ with respect to the shift amounts of ±0° through ±6° of the optical axis azimuth angles θ₁, θ₂ in the case in which the phase difference Γ₁ of the first wave plate and the phase difference Γ₂ of the second wave plate are set as the following expressions in the laminated quarter wave plate with the center wavelength of 660 nm.

Γ₁=360°+γ+7×360°=2880°+γ

Γ₂=Γ₁−90°=2790°+γ

According to the drawing, it is confirmed that by setting the allowable deviations k₁, k₂ of the optical axis azimuth angles θ₁, θ₂ to be ±4°, and the allowable deviation γ of the phase difference Γ₁ to be ±90°, the ellipticity no less than the target reference value of 0.85 can always be realized.

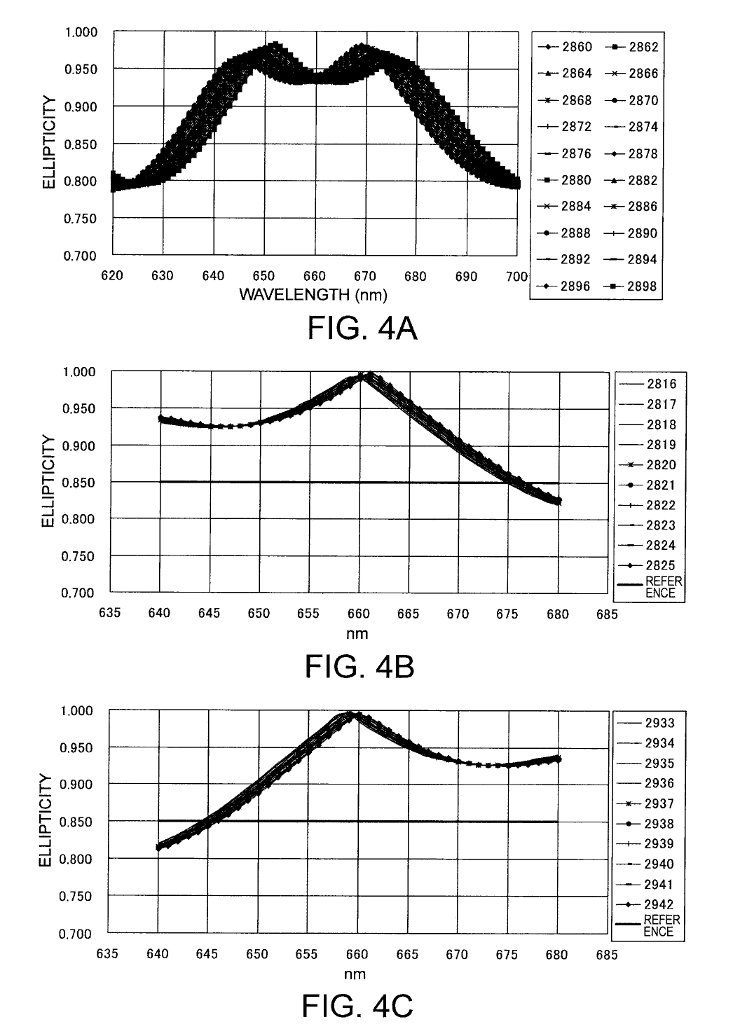

FIG. 4A shows a variation in the ellipticity to the wavelength in the range of the phase difference Γ₁=2880°±20°, in the case in which the shift amounts of the optical axis azimuth angles θ₁, θ₂ are set to be −2°, +2°, respectively, in the laminated quarter wave plate similarly with the center wavelength of 660 nm. In this case, it is understood that the ellipticity no lower than the target reference value of 0.85 can always be realized in the range of use of the wavelength λ=660±15 nm. Further, FIG. 4B shows a variation in the ellipticity in the case in which the phase difference Γ₁ is shifted significantly to the negative side of 2880°−64° through −55° in detail, and FIG. 4C shows a variation in the ellipticity in the case in which the phase difference Γ₁ is shifted significantly to the positive side of 2880°+53° through +62° in detail. Based on these drawings, the allowable deviation γ of the phase difference Γ₁ to be the limit with which the ellipticity no lower than the target reference value of 0.85 can be achieved.

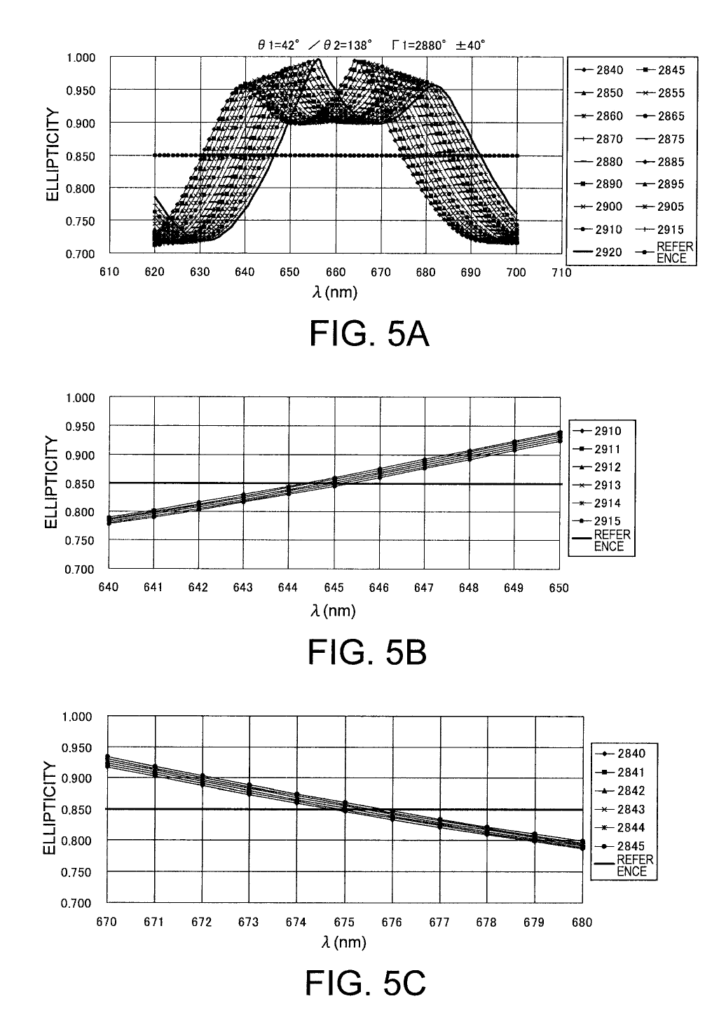

FIG. 5A shows a variation in the ellipticity to the wavelength in the range of the phase difference Γ₁=2880°±40°, in the case in which the shift amounts of the optical axis azimuth angles θ₁, θ₂ are set to be −3°, +3°, respectively, in the laminated quarter wave plate similarly with the center wavelength of 660 nm. It is understood that also in this case, the ellipticity no lower than the target reference value of 0.85 can always be realized in the range of use of the wavelength λ=660±15 nm. Further, FIG. 5B shows a variation in the ellipticity in the negative side of the phase difference Γ₁, namely in the value of 2880°−40° through −35° in detail, and FIG. 4C shows a variation in the ellipticity in the case in which the phase difference F1 is shifted to the positive side up to the value of 2880°+40° through +45° from the range described above in detail. Based on these drawings, the allowable deviation γ of the phase difference Γ₁ to be the limit with which the ellipticity no lower than the target reference value of 0.85 can be achieved can be determined.

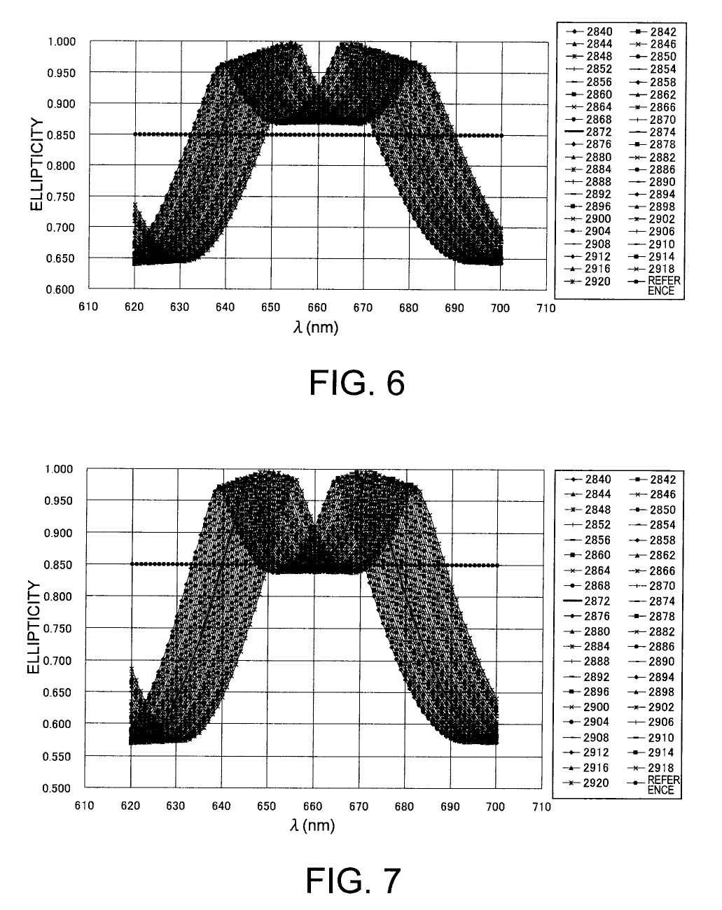

FIG. 6 shows a variation in the ellipticity to the wavelength in the range of the phase difference Γ₁=2880°±40°, in the case in which the shift amounts of the optical axis azimuth angles θ₁, θ₂ are set to be −4°, +4°, respectively, in the laminated quarter wave plate similarly with the center wavelength of 660 nm. According to the drawing, it is understood that also in this case, the ellipticity no lower than the target reference value of 0.85 can always be realized in the range of use of the wavelength λ=660±15 nm.

FIG. 7 shows a variation in the ellipticity to the wavelength in the range of the phase difference Γ₁=2880°±40°, in the case in which the shift amounts of the optical axis azimuth angles θ₁, θ₂ are set to be −5°, +5°, respectively, in the laminated quarter wave plate similarly with the center wavelength of 660 nm. According to the drawing, it is understood that, in this case, the range in which the ellipticity underruns the target reference value of 0.85 always exists in the range of use of the wavelength λ=660±15 nm.

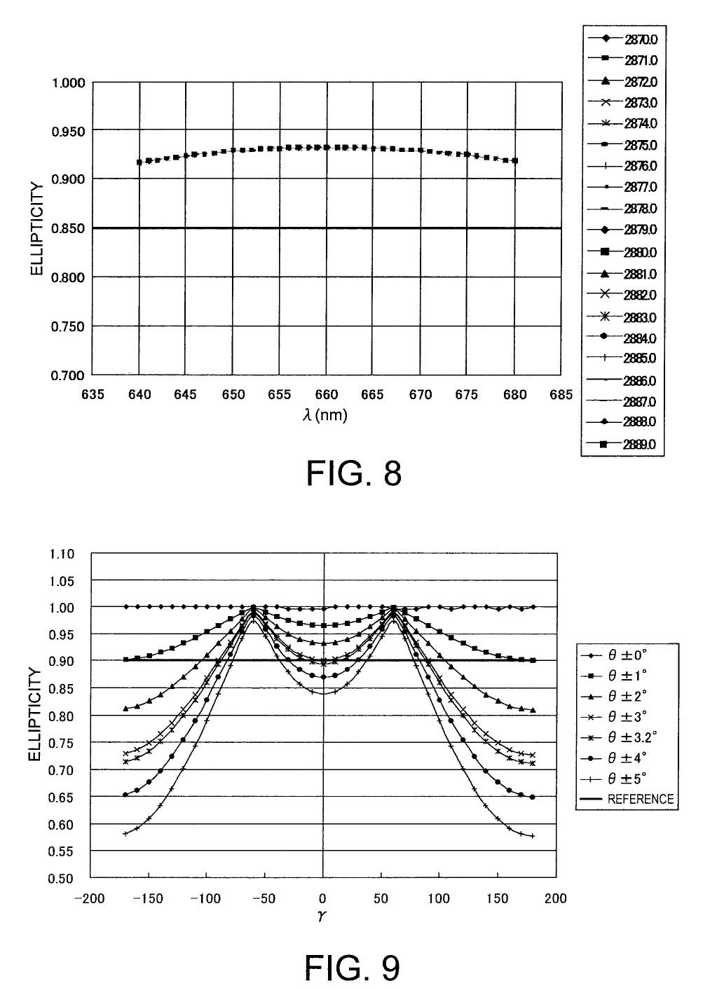

FIG. 8 shows a variation in the ellipticity to the wavelength in the range of the phase difference Γ₁=2880°±20°, in the case in which the shift amounts of the optical axis azimuth angles θ₁, θ₂ are set to be −2°, respectively, in the laminated quarter wave plate similarly with the center wavelength of 660 nm. According to the drawing, it is understood that, also in this case, the high ellipticity significantly exceeding the target reference value of 0.85 can always be realized in a broad range including the range of use of the wavelength λ=660±15 nm.

When taking these simulation results together, the range of the phase difference Γ₁ with which the ellipticity no lower than the target reference value of 0.85 can be achieved in the range of use of the wavelength λ=660±15 nm with respect to the shift amounts of the optical axis azimuth angles θ₁, θ₂ of ±1° through ±5°, namely the allowable deviation γ thereof can be summarized as Table 1 below. In the table, “shift amount of θ” denotes the shift amounts of the optical axis azimuth angles θ₁, θ₂.

TABLE 1

| SHIFT AMOUNT | | |
|---|---|---|
| OF θ | Γ₁ | Γ₂ |
| ±1° | THE SAME AS 360 ± 0° + 360° × 7 | Γ₁ − 90° |
| ±2° | 360 − 63/+56° + 360° × 7 | Γ₁ − 90° |
| ±3° | 360 − 38/+33° + 360° × 7 | Γ₁ − 90° |
| ±4° | 360 − 26/+22° + 360° × 7 | Γ₁ − 90° |
| ±5° | NG | Γ₁ − 90° |

Further, the laminated quarter wave plate 1 of the present embodiment can be used in a commercially available Blu-ray standard optical pickup device by setting the center wavelength thereof to be 405 nm. In this case, by setting the allowable deviations k₁, k₂ of the optical axis azimuth angles θ₁, θ₂ of the first wave plate 2 and the second wave plate 3 to be ±2.5°, a desired high ellipticity of 0.9 or more can be obtained. In a similar manner, explanations will be presented while showing specific simulation results.

FIG. 9 shows a variation in the ellipticity to the allowable deviation γ of the phase difference Γ₁ with respect to the shift amounts of ±0° through ±5° of the optical axis azimuth angles θ₁, θ₂ in the case in which the phase difference Γ₁ of the first wave plate and the phase difference Γ₂ of the second wave plate are set as the following expressions in the laminated quarter wave plate with the center wavelength of 405 nm.

Γ₁=360°+γ+9×360°=3600°+γ

Γ₂=Γ₁−90°=3510°+γ

According to the drawing, it is confirmed that by setting the allowable deviations k₁, k₂ of the optical axis azimuth angles θ₁, θ₂ to be ±3°, and the allowable deviation γ of the phase difference Γ₁ to be ±90°, the ellipticity no lower than the target reference value of 0.9 can always be realized.

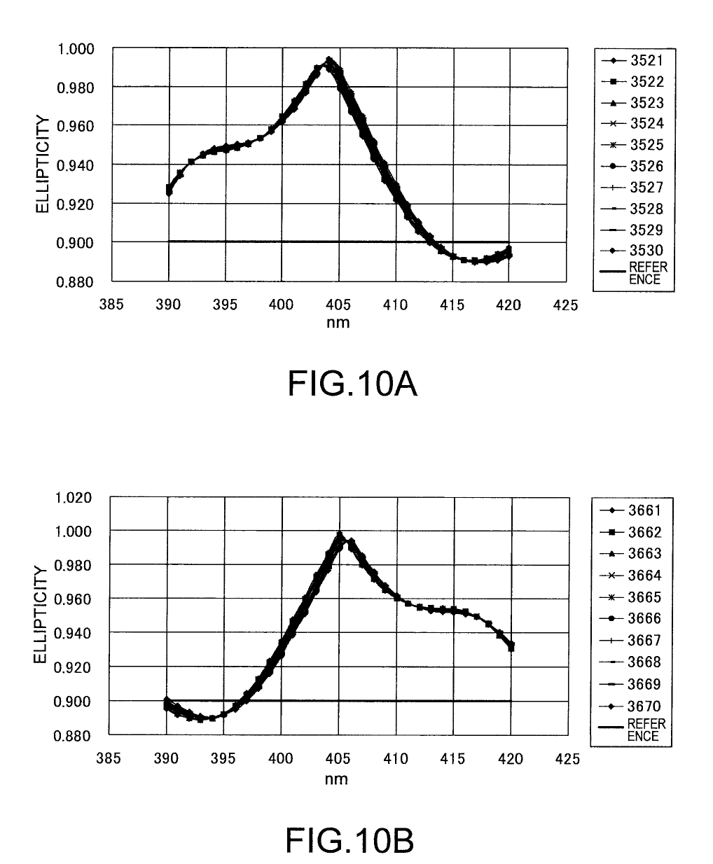

FIG. 10A shows a variation in the ellipticity to the wavelength when the phase difference Γ₁ is significantly shifted toward the negative side up to 3600°−79° through −70°, in the case in which the shift amounts of the optical axis azimuth angles θ₁, θ₂ are set to be −1°, +1°, respectively, in the laminated quarter wave plate similarly with the center wavelength of 405 nm. FIG. 10B shows a variation in the ellipticity when the phase difference Γ₁ is significantly shifted toward the positive side up to 3600°+61° through +70°. According to the drawing, it is understood that, in this case, the ellipticity no lower than the target reference value of 0.9 can always be realized in the range of use of the wavelength λ=405±8 nm.

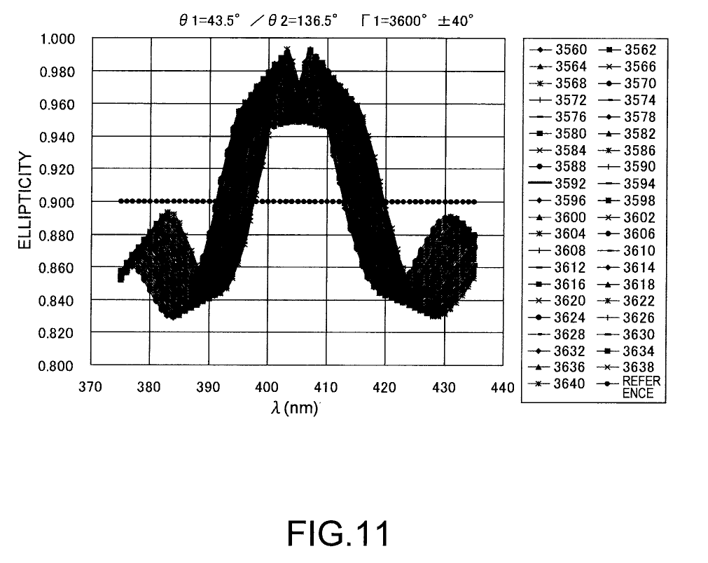

FIG. 11 shows a variation in the ellipticity to the wavelength in the range of the phase difference Γ₁=3600°±40°, in the case in which the shift amounts of the optical axis azimuth angles θ₁, θ₂ are set to be −1.5°, +1.5°, respectively, in the laminated quarter wave plate similarly with the center wavelength of 405 nm. According to the drawing, it is understood that, in this case, the ellipticity no lower than the target reference value of 0.9 can always be realized in the range of use of the wavelength λ=405±8 nm.

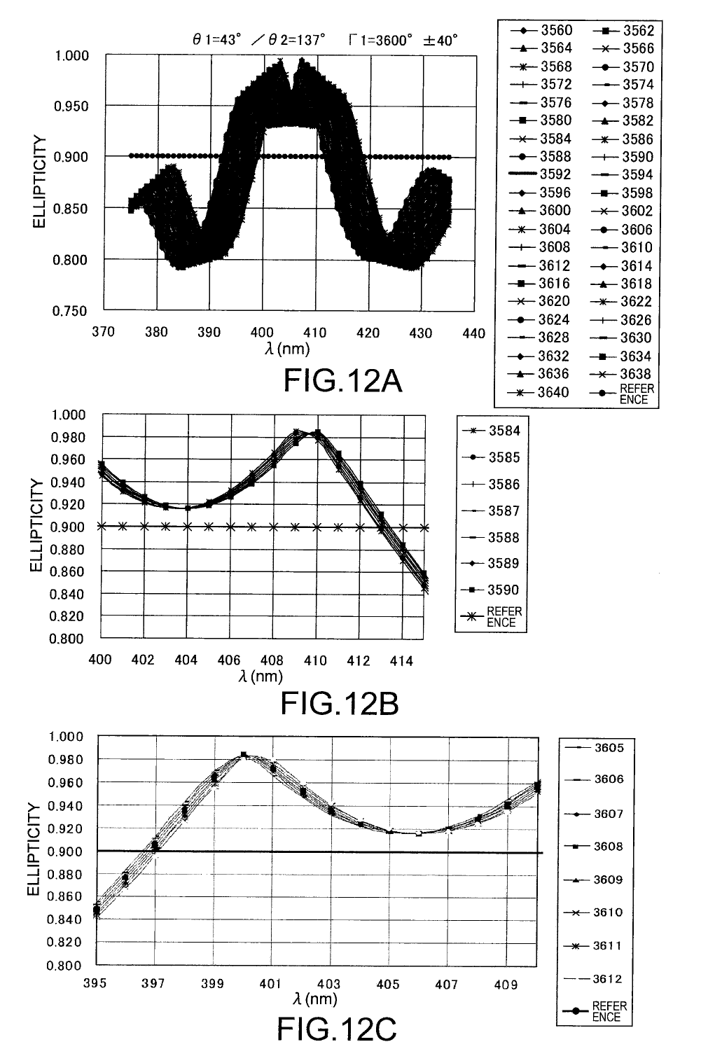

FIG. 12A shows a variation in the ellipticity to the wavelength in the range of the phase difference Γ₁=3600°±20°, in the case in which the shift amounts of the optical axis azimuth angles θ₁, θ₂ are set to be −2°, +2°, respectively, in the laminated quarter wave plate similarly with the center wavelength of 405 nm. It is understood that also in this case, the ellipticity no lower than the target reference value of 0.9 can always be realized in the range of use of the wavelength λ=405±8 nm. Further, FIG. 12B shows a variation in the ellipticity in the negative side of the phase difference F1, namely in the value of 3600°−16° through −10° in detail, and FIG. 12C shows a variation in the ellipticity in the positive side of the phase difference F1, namely in the value of 3600°+5° through +12° in detail. Based on these drawings, the allowable deviation γ of the phase difference Γ₁ to be the limit with which the ellipticity no lower than the target reference value of 0.9 can be achieved can be determined.

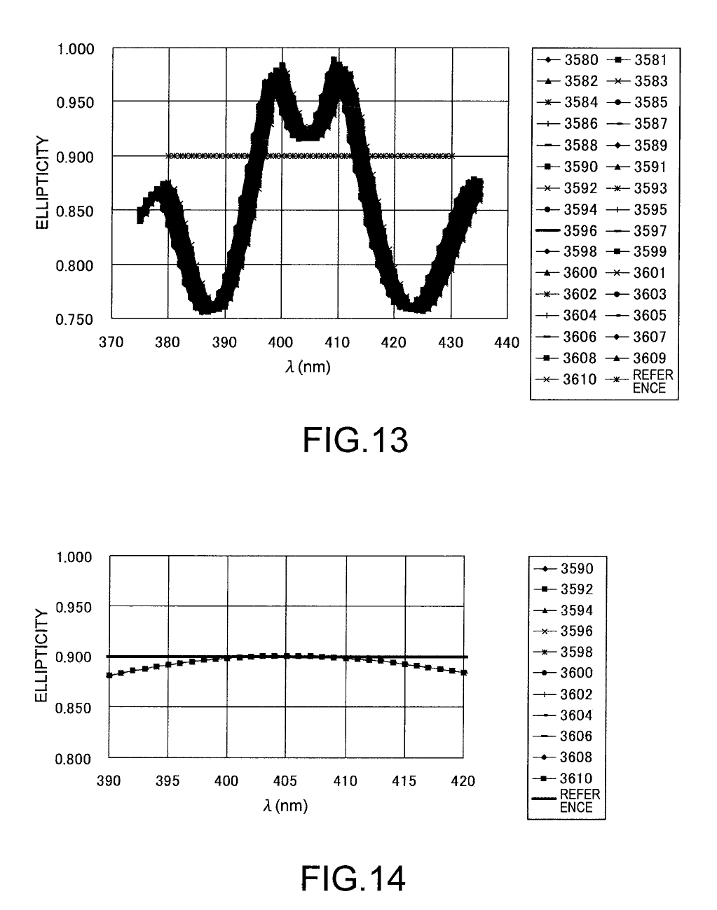

FIG. 13 shows a variation in the ellipticity to the wavelength in the range of the phase difference Γ₁=3600°−20° through +10°, in the case in which the shift amounts of the optical axis azimuth angles θ₁, θ₂ are set to be −2.5°, +2.5°, respectively, in the laminated quarter wave plate similarly with the center wavelength of 405 nm. According to the drawing, it is understood that also in this case, the ellipticity no lower than the target reference value of 0.9 can always be realized in the range of use of the wavelength λ=405±8 nm.

FIG. 14 shows a variation in the ellipticity to the wavelength in the range of the phase difference Γ₁=3600°±10°, in the case in which the shift amounts of the optical axis azimuth angles θ₁, θ₂ are set to be −3°, +3°, respectively, in the laminated quarter wave plate similarly with the center wavelength of 405 nm. According to the drawing, it is confirmed that, in this case, the ellipticity no lower than the target reference value of 0.9 cannot be realized in the range of use of the wavelength λ=405±8 nm.

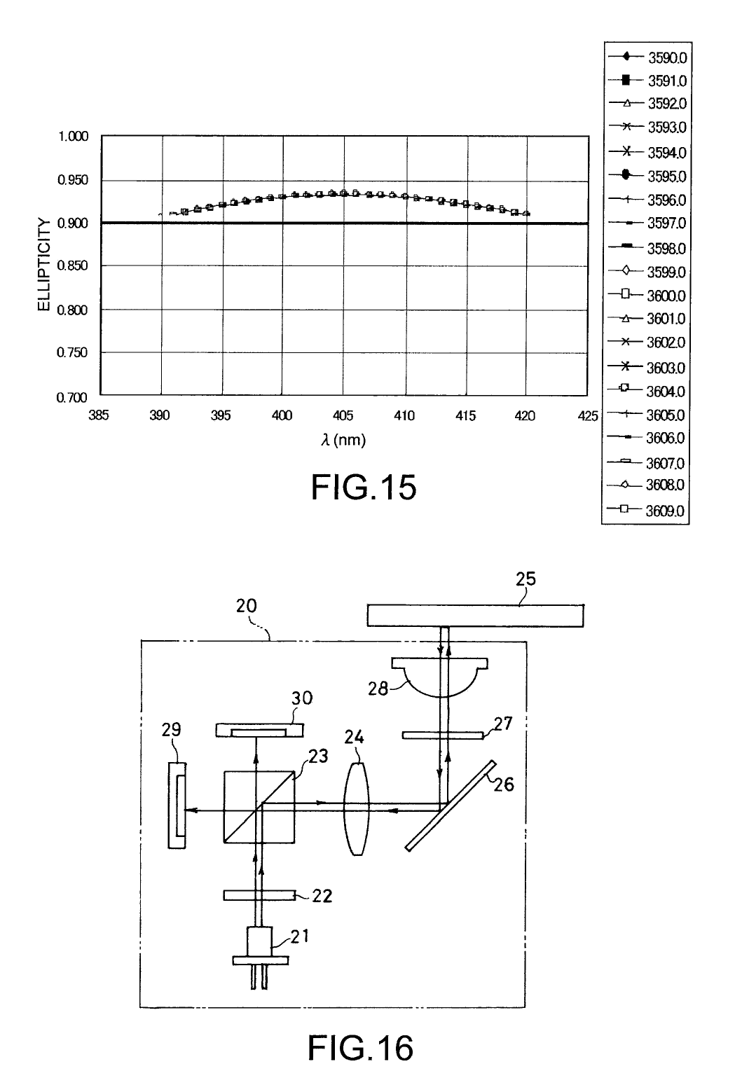

FIG. 15 shows a variation in the ellipticity to the wavelength in the range of the phase difference Γ₁=3600°±10°, in the case in which the shift amounts of the optical axis azimuth angles θ₁, θ₂ are set to be −2°, respectively, in the laminated quarter wave plate similarly with the center wavelength of 405 nm. According to the drawing, it is understood that, also in this case, the high ellipticity significantly exceeding the target reference value of 0.9 can always be realized in a broad range including the range of use of the wavelength λ=405±8 nm.

When taking these simulation results together, the range of the phase difference Γ₁ with which the ellipticity no lower than the target reference value of 0.9 can be achieved in the range of use of the wavelength λ=405±8 nm with respect to the shift amounts of the optical axis azimuth angles θ₁, θ₂ of ±1° through ±3°, namely the allowable deviation γ thereof can be summarized as Table 2 below.

TABLE 2

| SHIFT AMOUNT | | |
|---|---|---|
| OF θ | Γ₁ | Γ₂ |
| ±1° | 360 − 78/+69° + 360° × 9 | Γ₁ − 90° |
| ±1.5° | 360 − 36/+30° + 360° × 9 | Γ₁ − 90° |
| ±2° | 360 − 22/+16° + 360° × 9 | Γ₁ − 90° |
| ±2.5° | 360 − 14/+9° + 360° × 9 | Γ₁ − 90° |
| ±3° | NG | Γ₁ − 90° |

FIG. 16 shows an optical pickup device as an embodiment of the invention to which the laminated quarter wave plate of the above embodiment of the invention is applied. The optical pickup device 20 is for use in recording/reproduction of an optical disk drive such as Blu-ray Disc (trademark), and has a light source 21 formed of a laser diode emitting a laser beam as blue-violet light with a wavelength of 405 nm, for example. The optical pickup device 20 is provided with a diffraction grating 22 for diffracting the laser beam from the light source 21 to form three beams, a polarizing beam splitter 23 for splitting the laser beams transmitted through the diffraction grating into a P-polarization component and an S-polarization component and transmitting or reflecting them, a collimating lens 24 for collimating the laser beam reflected by the polarizing beam splitter into a parallel light beam, a mirror 26 for reflecting the laser beam, which is transmitted through the collimating lens, toward an optical disk 25, a quarter wave plate 27 for converting the laser beam as linearly polarized light reflected by the mirror into circularly polarized light, an objective lens 28 for condensing the laser beam transmitted through the quarter wave plate, and a light detector 29 for detecting the laser beam reflected by the optical disk 25. Further, the optical pickup device 20 has a monitoring light detector 30 for detecting the laser beam emitted from the light source 21 and transmitted through the polarizing beam splitter 23.

The operation of the optical pickup device 20 will hereinafter be explained. The laser beam as the linearly polarized light emitted from the light source 21 is split by the diffraction grating 22 into three beams for tracking control by the three-beam method, and then the S-polarization component thereof is reflected by the polarizing beam splitter 23, and formed as the parallel light by the collimating lens 24. The laser beam as the parallel light is totally reflected by the mirror 26, converted by the quarter wave plate 27 from the linearly polarized light to the circularly polarized light, condensed by the objective lens 28, and applied to a pit of a signal recording layer provided to the optical disk 25. The laser beam reflected by the pit is transmitted through the objective lens, converted by the quarter wave plate 27 from the circularly polarized light to the linearly polarized light, totally reflected by the mirror 26, transmitted through the collimating lens 24 and the polarizing beam splitter 23, and input to and then detected by the light detector 29. Thus, the operation of reading the signal recorded on the optical disk is performed. Further, the P-polarization component of the laser beam thus emitted from the light source 21 is transmitted through the polarizing beam splitter 23, and input to and then detected by the monitoring light detector 30. Based on the detection output, the output of the laser beam emitted from the laser diode is controlled.

The optical pickup device uses the laminated quarter wave plate according to the embodiment of the invention as the quarter wave plate 27. Thus, it becomes possible to convert the laser beam of the linearly polarized light into the substantial and circularly polarized light with a high ellipticity without coming under the influence of the optical rotatory power of the quartz crystal. As a result, the optical pickup device suitable for the optical disk recording/reproducing drive with higher recording density can be realized.

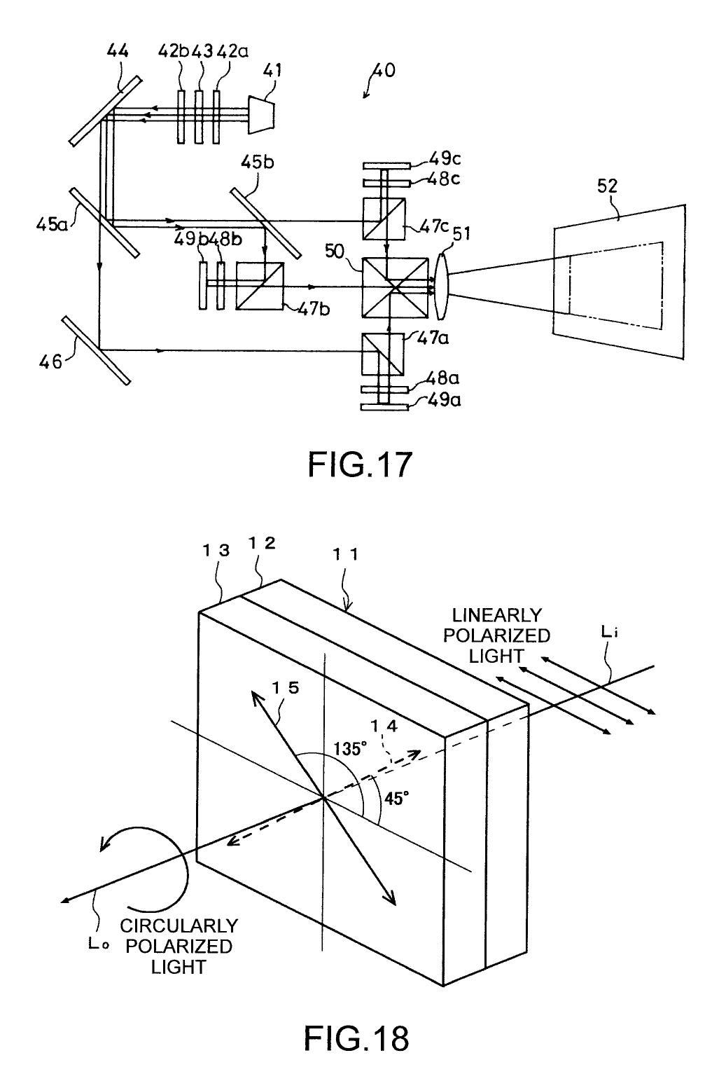

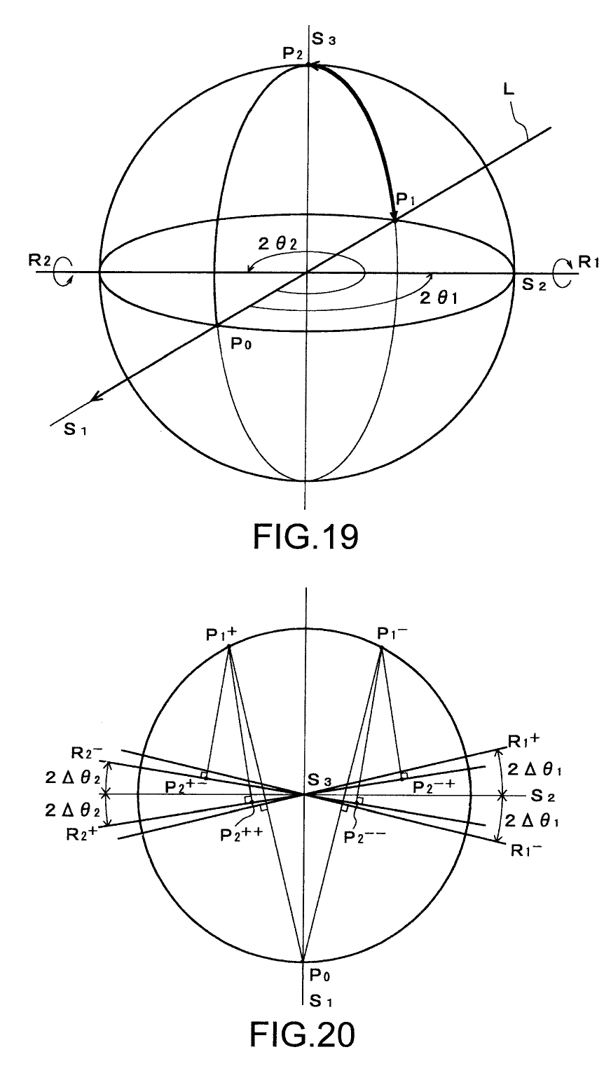

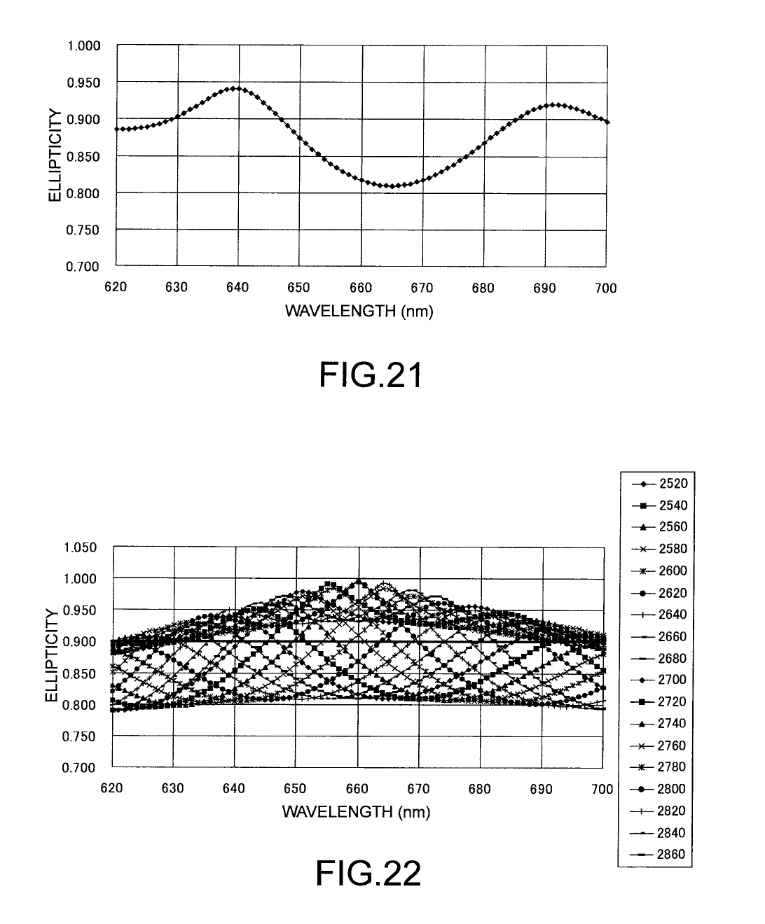

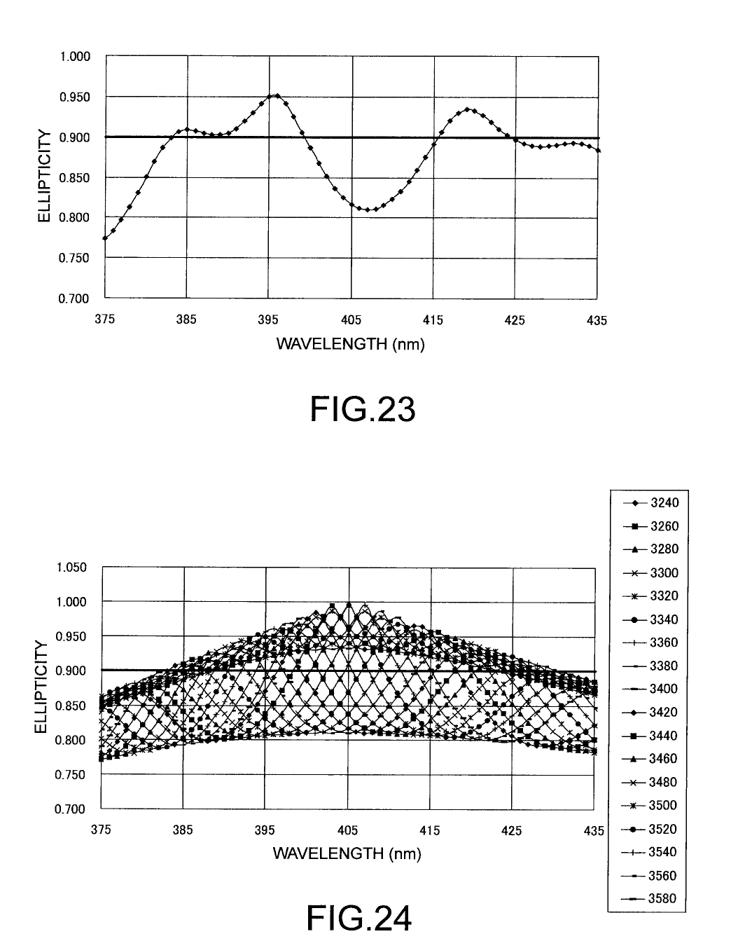

FIG. 17 shows an LCOS projector as an example of a reflective liquid crystal display device of an embodiment of the invention to which the laminated quarter wave plate according to the embodiment of the invention is applied. The liquid crystal projector 40 is provided with a light source 41, first and second integrator lenses 42a, 42b, a polarization conversion element 43, a cold mirror 44, first and second dichroic mirrors 45a, 45b forming a color separation optical system, and a folding mirror 46. Further, the projector is provided with polarizing beam splitters 47a, 47b, 47c respectively for red, green, and blue, quarter wave plates 48a, 48b, 48c respectively for red, green, and blue, reflective liquid crystal display elements 49a, 49b, 49c formed respectively of liquid crystal on silicon (LCOS) for red, green, and blue, a cross prism 50 forming a color composition optical system, a projection lens 51, and a screen 52.

The operation of the liquid crystal projector 40 will hereinafter be explained. Random light emitted from the light source 41 is formed as parallel light by the first integrator lens 42a, P-polarization component thereof is converted by the polarization conversion element 43 into S-polarized light while the S-polarization component thereof is directly transmitted, the light thus transmitted is formed as parallel light by the second integrator lens 42b, and is input to the cold mirror 44. The green light and the blue light among the light reflected by the cold mirror are reflected by the first dichroic mirror 45a, while the red light thereof is transmitted therethrough and reflected by the folding mirror 46. The red light, which is S-polarized light, is reflected by a polarization film of the polarizing beam splitter 47a, transmitted through the quarter wave plate 48a, and input to and then reflected by the LCOS 49a. In this case, the red light is modulated, then converted into the P-polarized light while being transmitted through the quarter wave plate 48a again, and input to the cross prism 50 after transmitted through a polarization film of the polarizing beam splitter 47a.

The green light reflected by the first dichroic mirror is further reflected by the second dichroic mirror 45b, then reflected by a polarization film of the polarizing beam splitter 47b because it is S-polarized light, then transmitted through the quarter wave plate 48b, and input to and then reflected by the LCOS 49b. In this case, the green light is modulated, then converted into the P-polarized light while being transmitted through the quarter wave plate 48b again, and input to the cross prism 50 after transmitted through a polarization film of the polarizing beam splitter 47b. The blue light similarly reflected by the first dichroic mirror is transmitted through the second dichroic mirror 45b, then reflected by the polarizing beam splitter 47 because it is S-polarized light, then transmitted through the quarter wave plate 48c, and input to and then reflected by the LCOS 49c. In this case, the blue light is modulated, then converted into the P-polarized light while being transmitted through the quarter wave plate 48c again, and input to the cross prism 50 after transmitted through the polarizing beam splitter 47c.

The cross prism 50 is configured so as to reflect the red light and the blue light input therein and transmit the green light. Therefore, the color composition is executed on the red light, the green light, and the blue light input to the cross prism, and the result is projected on the screen 52 via the projection lens 51, thereby obtaining a color image.

The liquid crystal projector uses the laminated quarter wave plate of the embodiment of the invention as each of the quarter wave plates 48a, 48b, 48c for respective colors of red, green, and blue. Thus, it becomes possible to convert the laser beam of the linearly polarized light into the substantial and circularly polarized light with a high ellipticity without coming under the influence of the optical rotatory power of the quartz crystal. As a result, the reflective liquid crystal display device with improved contrast in comparison with the related art can be realized.

The invention is not limited to the embodiments described above, but can be put into practice with modifications or changes applied thereto within the scope and spirits of the invention. For example, the phase difference F2 of the second wave plate 3 can be set as Γ₂=Γ₁−270°. In this case, since the outgoing light of the laminated quarter wave plate comes to the south pole position on the Poincare sphere, and the phase difference has wavelength dependency, the gradient of the variation in the ellipticity to the wavelength becomes greater than in the case of the embodiments described above. Further, in the embodiments of the invention, the first and second wave plates can be made of an optically uniaxial crystal material other than the quartz crystal such as calcite, and also in such a case, substantially the same functions and advantages can be obtained.

The entire disclosure of Japanese Patent Application No. 2008-282531, filed Oct. 31, 2008 is expressly incorporated by reference herein.

What is claimed is:

1. A laminated quarter wave plate comprising:
a first wave plate made of an optically uniaxial crystal material; and
a second wave plate made of an optically uniaxial crystal material,
wherein the first and second wave plates are disposed in this order from an entrance side of light so that the optical axes of the first and second wave plates intersect with each other at an angle of 90°, and
a phase difference Γ₁ of the first wave plate, a phase difference Γ₂ of the second wave plate, an optical axis azimuth angle θ₁ of the first wave plate, an optical axis azimuth angle θ₂ of the second wave plate, an allowable deviation γ of the phase difference of the first wave plate, allowable deviations k₁, k₂ of the optical axis azimuth angles of the first and second wave plates satisfy the following relation:
Γ₁=360°+γ+n×360°, wherein −90°≦γ≦+90°, and n is a nonnegative integer;
Γ₂=Γ₁−90° or Γ₂=Γ₁−270°;
θ₁=45°+k₁; and
θ₂=135°+k₂,
and wherein γ, k₁, k₂ are determined so that a polarization state of outgoing light satisfies a desired ellipticity.

2. The laminated quarter wave plate according to claim 1, wherein
a center wavelength is 660 nm, and
the allowable deviations k₁, k₂ of the optical axis azimuth angles of the first and second wave plates are ±4°, respectively.

3. The laminated quarter wave plate according to claim 1, wherein
a center wavelength is 405 nm, and
the allowable deviations k₁, k₂ of the optical axis azimuth angles of the first and second wave plates are ±2.5°, respectively.

4. The laminated quarter wave plate according to claim 1, wherein
the first and second wave plates are each formed of a quartz crystal plate.
